(19) United States
(12) Patent Application Publication
(10) Pub. No.: US 2006/0219115 A1
(43) Pub. Date: Oct. 5, 2006

(54) Web offset printing press with autoplating

(75) Inventors: Brian Joseph Gentle, Rochester, NH (US); Matt Alan Taylor, Barrington, NH (US); Bryan Charles Dustin, Strafford, NH (US); Keith Andrew Cornish, Barrington, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/388,601

(22) Filed: Mar. 24, 2006

Related U.S. Application Data
(60) Provisional application No. 60/666,360, filed on Mar. 30, 2005.

(51) Int. Cl. B41F 1/28

(52) U.S. Cl. 101/415.1

(57) ABSTRACT

An offset web print unit includes a plate cylinder, a blanket cylinder, a second blanket cylinder, an autoplating mechanism, and a throw-off mechanism including a single actuator both for moving the blanket cylinder from the second blanket cylinder and for moving the blanket cylinder to selectively contact the plate cylinder to permit autoplating while the blanket cylinder is thrown-off of the second blanket cylinder. Methods are also provided.

This application claims priority to U.S. Provisional Application No. 60/666,360 filed Mar. 30, 2005, and hereby incorporated by reference herein.

### BACKGROUND

The present invention relates generally to printing presses and more specifically to web offset printing presses having separable blankets.

U.S. Pat. No. 4,240,346 describes for example a printing press with two blanket cylinders separable from each other to permit a blanket throw off. In such presses, the blankets are offset from a vertical from each other, and in order to pass the web through the blankets when the blankets are offset, lead rolls or air bars are necessary to properly guide the web through the blankets. These guides can mark the printed product and also alter registration of the web between two printing print units, causing deteriorated print quality.

U.S. Pat. Nos. 6,216,592 and 6,019,039 describe printing units with throw-off mechanisms and are hereby incorporated by reference herein.

### SUMMARY OF THE INVENTION

The present invention provides an offset web print unit comprising:

a plate cylinder;

a blanket cylinder;

a second blanket cylinder;

an autoplating mechanism, and

a throw-off mechanism including a single actuator both for moving the blanket cylinder from the second blanket cylinder and for moving the blanket cylinder to selectively contact the plate cylinder to permit autoplating while the blanket cylinder is thrown-off of the second blanket cylinder.

The present invention also provides a method for autoplating comprising throwing off a blanket cylinder from a second blanket cylinder using an actuator, separating a plate cylinder from the blanket cylinder using the actuator; and plating the plate cylinder with a printing plate, the plating step including removing a used printing plate from the blanket cylinder.

### BRIEF DESCRIPTION OF THE DRAWINGS

Preferred embodiments of the present invention will be elucidated with reference to the drawings, in which:

FIG. 1 shows a web offset printing press;

FIG. 2 shows bearer cams for a lower print couple in a first printing position;

FIG. 3 shows bearer cams in a transition position;

FIG. 4 shows bearer cams in a first throw-off position with the plate and blanket cylinders in contact;

FIG. 5 shows bearer cams in a second throw-off position with the plate and blanket cylinders out of contact;

FIG. 6 shows schematically supports for an upper print couple in a printing position;

FIG. 7 shows the supports of FIG. 6 with the plate cylinder 48 moved away from blanket cylinder 46;

FIG. 8 shows the supports of Fig.6 with the blanket cylinder 46 thrown off blanket cylinder 44, and plate cylinder 48 apart from blanket cylinder 46; and

FIG. 9 shows the support of FIG. 6 with the blanket cylinder 46 thrown off but contacting plate cylinder 48.

### DETAILED DESCRIPTION

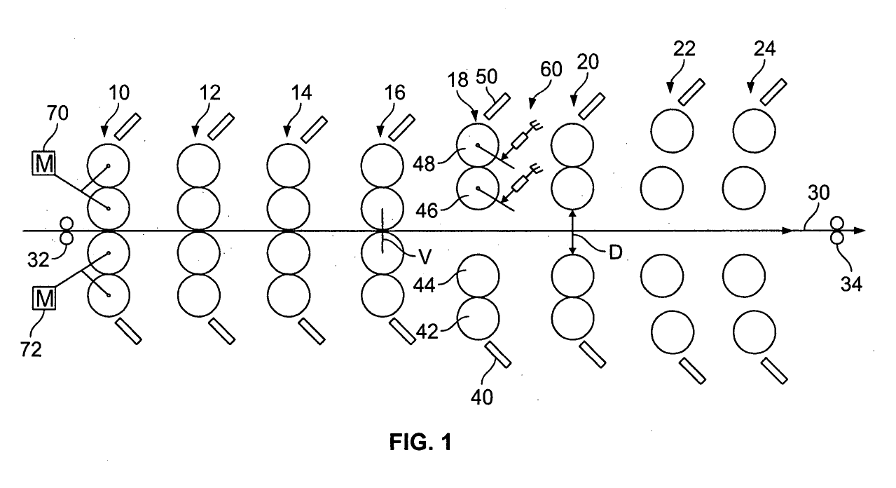

FIG. 1 shows a web offset printing press having eight offset print units 10, 12, 14, 16, 18, 20, 22, 24, each having a plate cylinder 42, blanket cylinder 44, plate cylinder 48 and blanket cylinder 46. Blanket cylinders 44 and 46 nip a web 30 in a printing mode, as shown for print units 10, 12, 14, 16, which may print black, cyan, yellow and magenta, respectively for example. The web may enter the print units via nip rollers 32 (which may be infeed rollers for example) and may exit via exit rollers 34, which may for example be located downstream of a dryer.

The blanket cylinders 44, 46 for each print unit may be thrown-off, as shown for units 22 and 24, so as to separate from each other and from the respective plate cylinder 42, 48. Plate cylinders 42, 48 may move back into contact with the blanket cylinders 44, 46, respectively, during an automatic plate change operation, for example via automatic plate changers 40 and 50, respectively. Automatic plate changers are described in U.S. Pat. Nos. 6,053,105, 6,460,457 and 6,397,751 and are hereby incorporated by reference herein.

A throw-off mechanism 60 is shown schematically for moving the blanket and plate cylinders 46, 48. Blanket cylinder 44 and plate cylinder 42 may have a similar throw-off mechanism. Preferably, each print unit is driven by two motors 70, 72, one driving one of the plate or blanket cylinders 46, 48, and one driving one of the plate cylinder 42 and blanket cylinder 44. The non-driven cylinder may be geared to the driven cylinder on each side of web 30. Each print unit 10, 12 . . . 24 may be the same.

The web path length between the nip rollers 32, 34 advantageously need not change, even when one of the print units has blanket cylinders which are thrown off. Registration may be unaffected by the throw-off. In addition, no web deflectors or stabilizers are needed, such as lead rolls or air rolls to make sure the web does not contact the blanket cylinders 44, 46, which could cause marking.

The throw-off distance D preferably is at least 0.5 inches and most preferably at least 1 inch, i.e. that the web has half an inch clearance on either side of the web. Moreover, the centers of the blanket cylinders 44, 46 preferably are in a nearly vertical plane V, which is preferably 10 degrees or less from perfect vertical. This has the advantage that the throw-off provides the maximum clearance for a horizontally traveling web.

The circumference of the plate cylinder preferably is less than 630 mm, and most preferably is 578 mm.

The creation of the large throw-off distance D is explained with an exemplary embodiment as follows:

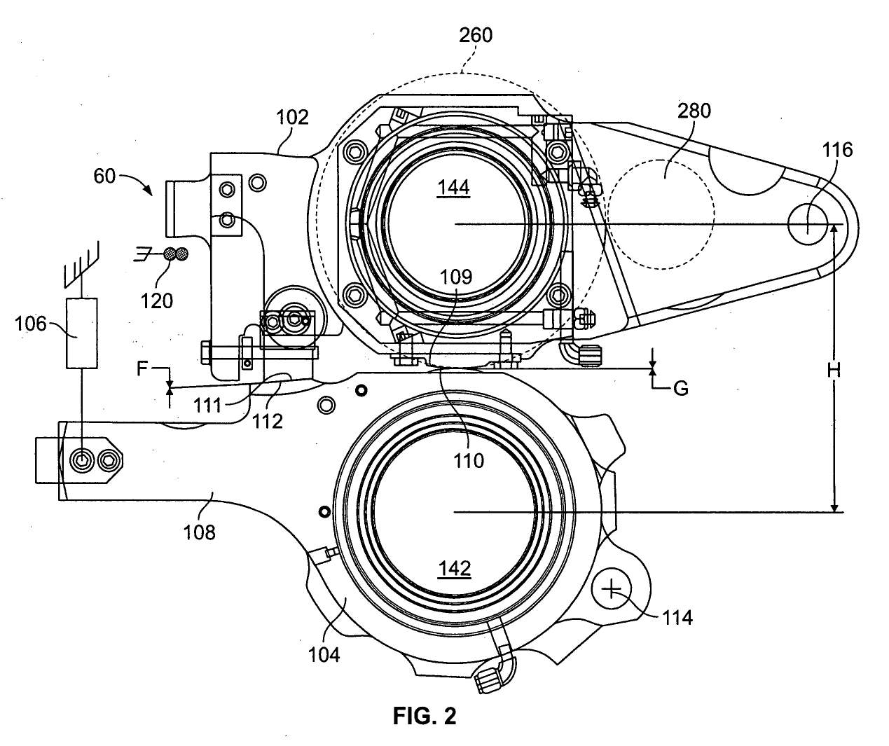

FIG. 2 shows the throw-off mechanism 60 for the lower blanket cylinder 44. A blanket cylinder support 102 supports a gear side axle 144 of the blanket cylinder 44 and a plate cylinder support 104 supports a gear side axle 142 of the plate cylinder 42. The blanket cylinder support 102 is pivotable about an axis 116, and the plate cylinder support about an axis 114. A pneumatic cylinder 106 can move the plate cylinder support 104 via an arm 108.

When blanket cylinder 44 is in contact with blanket cylinder 46 in a printing position, a first bearer surface 111 of support 102 is in contact with a second bearer surface 112 of support 104, which another bearer surface 109 of the support 102 is not in contact with a bearer surface 110 of support 104. Distance F thus is zero, while a distance G between surfaces 109 and 110 may be 0.0045 inches. Distance H between the axial centers of the axles 144 and 142 may be 7.2463 inches.

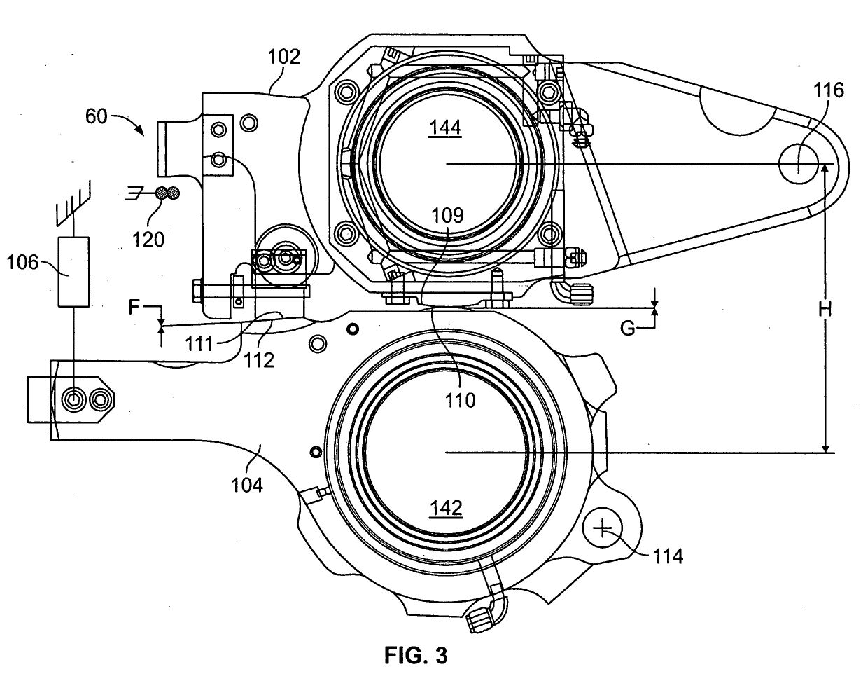

In FIG. 3, support 104 is moved downwardly so distance H maybe for example 7.2416 inches, and the distances F and G both are zero. The cam surfaces 111, 112 and 109, 110 thus are transitioning the load between themselves.

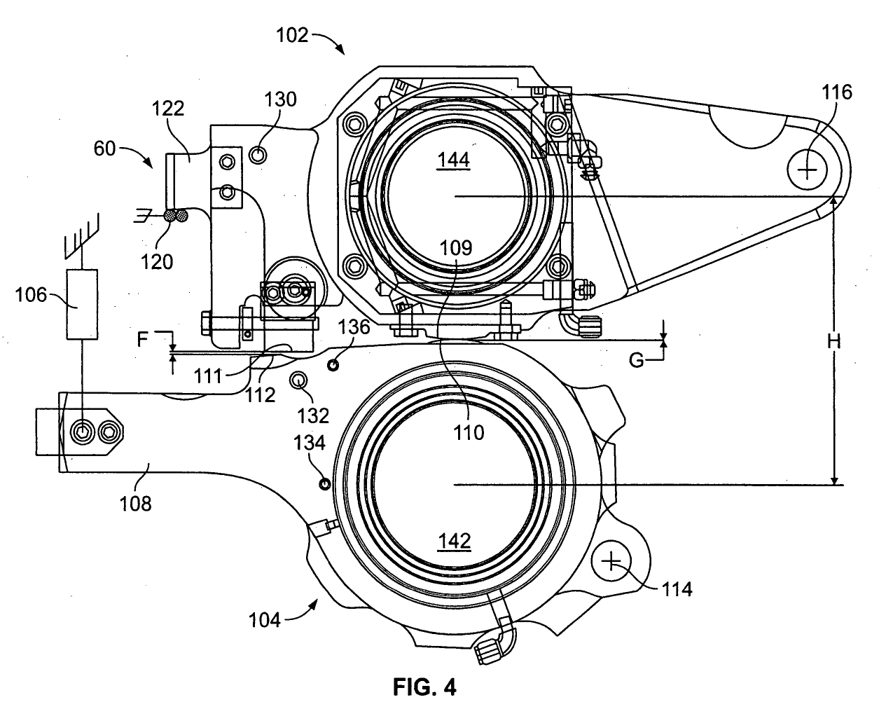

As shown in FIG. 4, when support 104 moves downwardly more, blanket cylinder 44 is thrown-off the blanket cylinder 46, bearer surface or cam 109 of support 102 contacts bearer surface 110 of the box 104 so that the blanket cylinder box 102 rests on the box 104 at surfaces 109/110. A distance between the bearer surface 111 of box 102 and a bearer surface 112 of box 104 may be 0.1561 inches. The bearer surface 109 may have a same arc of curvature as blanket cylinder 44, and bearer surface 110 may have a same arc of curvature as plate cylinder 42, so that even in FIG. 4 distance H still remains 7.2416 inches. At this point an extension 122 also just comes into contact with a fixed stop 120 on a frame.

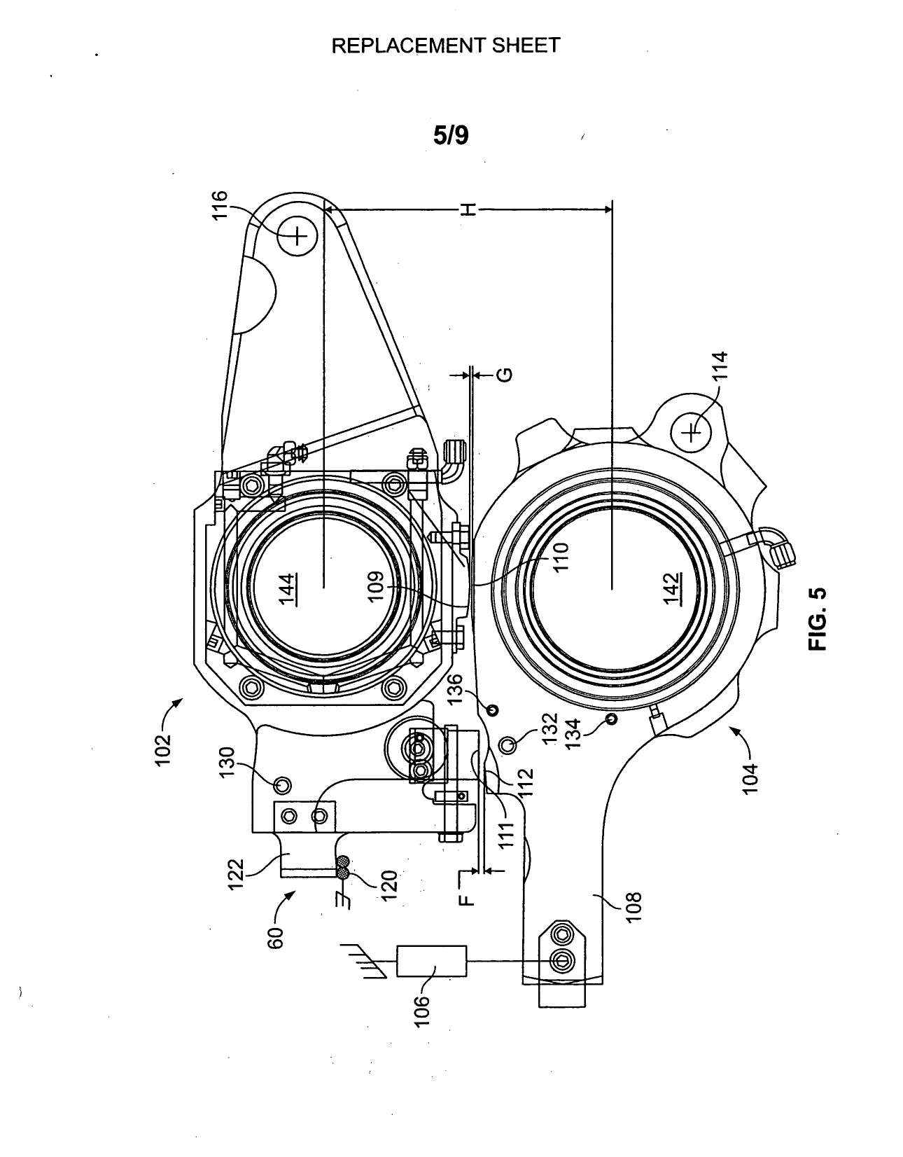

As shown in FIG. 5, when support 104 is moved downwardly more, blanket support 102 rests on stop 120 while plate support 104 moves downwardly even more. Thus, distance G between bearer surfaces 109 and 110 increases and may be 1 mm, for example. Distance F also increases. In this position, access to plate cylinder 42 for removing or changing a plate may be possible. For autoplating, the plate cylinder 42 may be moved again against the blanket cylinder 44 as in FIG. 4, if the autoplating mechanism so requires.

The upper plate and blanket throw-off mechanism also have dual bearer surfaces, but since the gravity effects differ, a link can be provided between similar holes 130, 132 in the upper supports so that the raising of the plate cylinder 48 also causes the blanket cylinder 46 to rise.

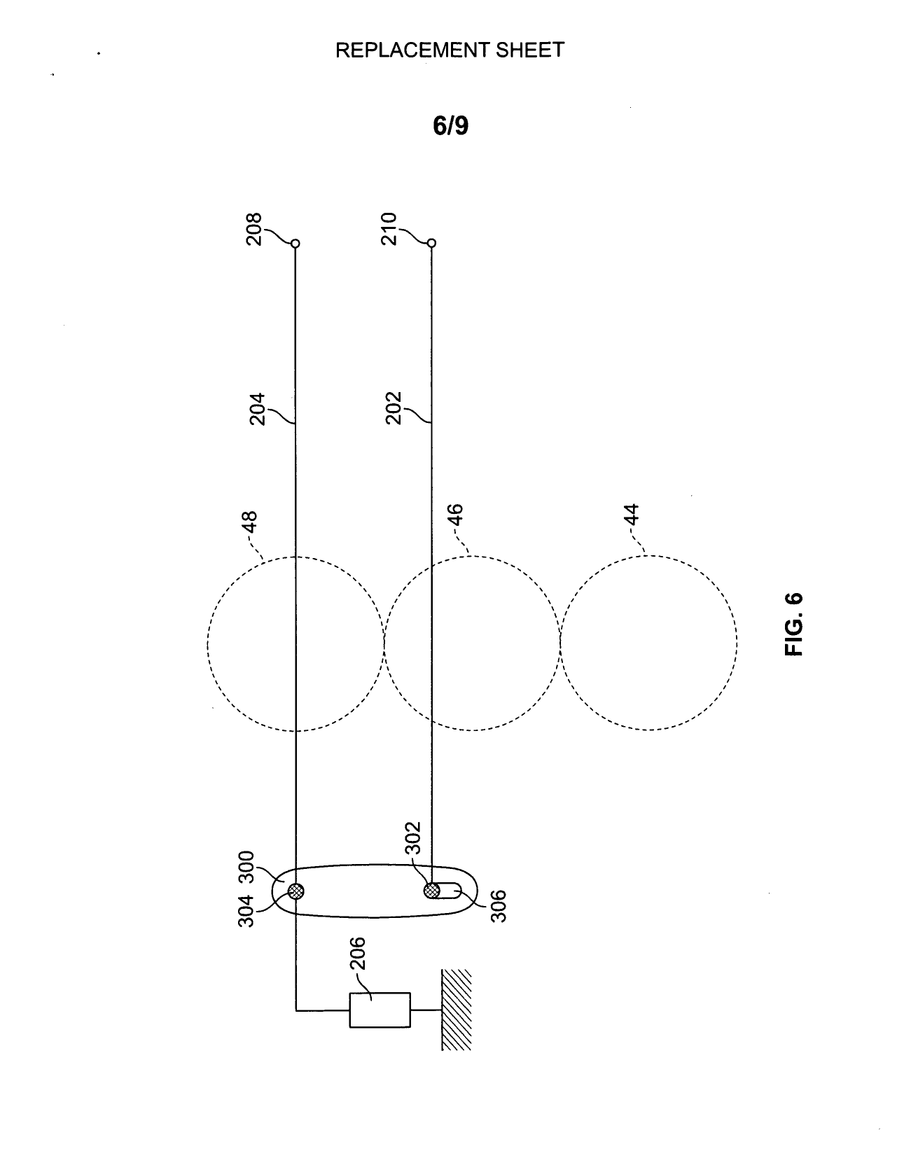

FIG. 6 shows schematically blanket cylinder support 202 and plate cylinder support 204 for the upper print couple 46, 48 in a printing position. A link 300 connects the supports 204 202 via pins 304 and 302. Pin 304 may be rotatable but does not permit translational movement of link 300 with respect to support 204. Pin 302 however is located in an elongated slot 306 of link 300 to permit some translational movement as will be described. An acutator 206 (which preferably is a device separate from actuator 106 but may be links connected to actuator 106) can rotate support 204 about a pivot 208.

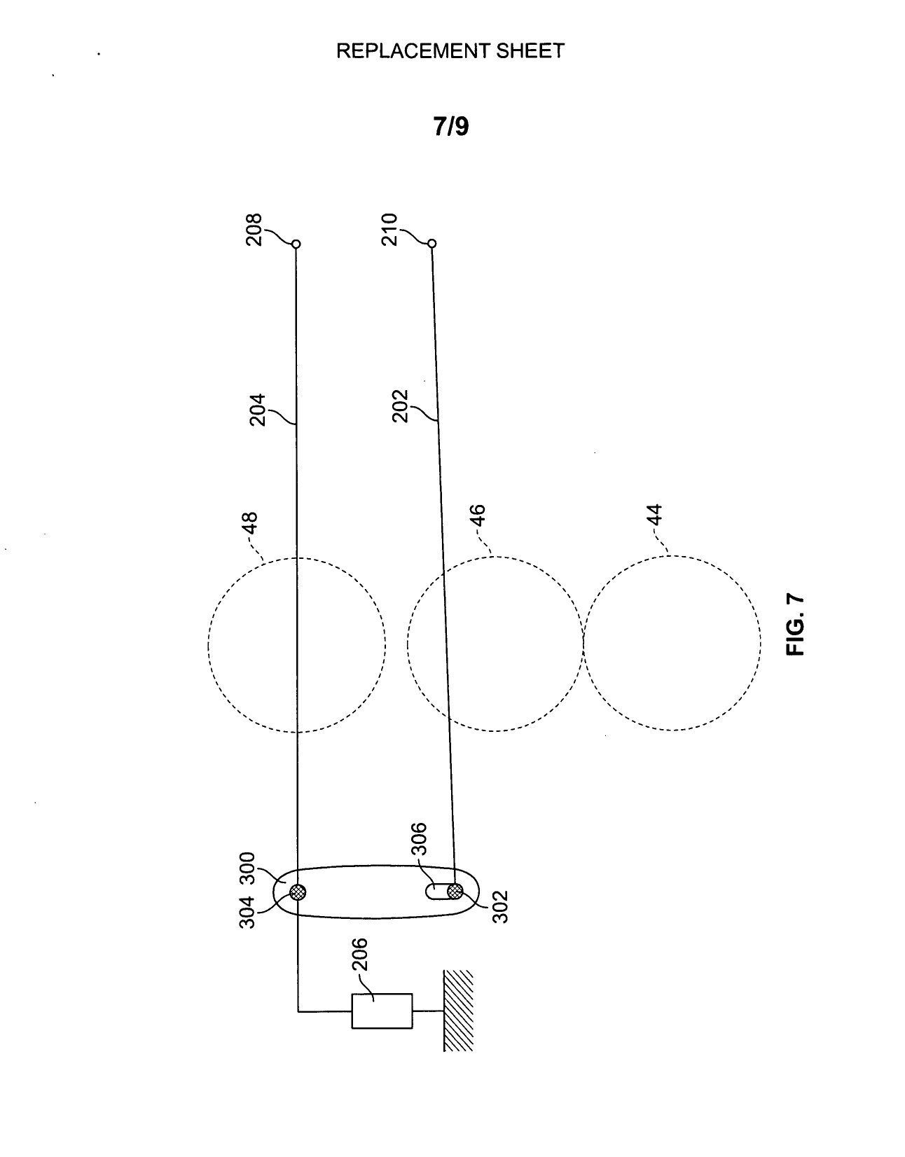

FIG. 7 shows the actuator 206 moving the plate cylinder 48 upwardly via support 204. Link 300 and slot 306 move to upwardly as well, but support 202 does not move as the pin 302 is not pulled upwardly due to the slot 306. The plate cylinder 48 moves away from blanket cylinder 46.

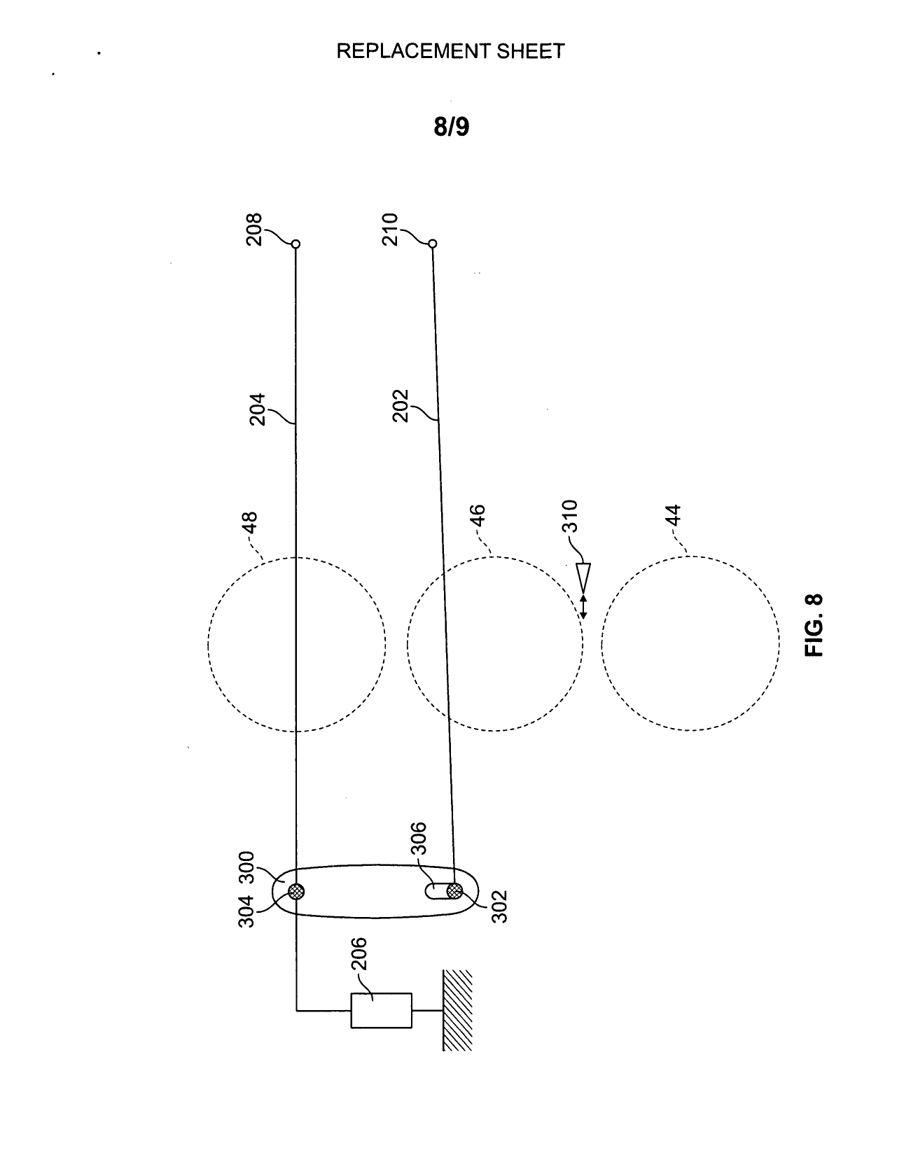

FIG. 8 shows the actuator 206 moving the plate cylinder support 204 even further upwardly and now the bottom of slot 306 pulls pin 302 upwardly to lift support 202 about pivot 210. The blanket cylinder 46 is thus thrown off blanket cylinder 44, and plate 48 is apart from blanket cylinder 46.

A wedge 310 can move under support 202 in this position to support blanket support 202 and blanket cylinder 46 in the thrown off position.

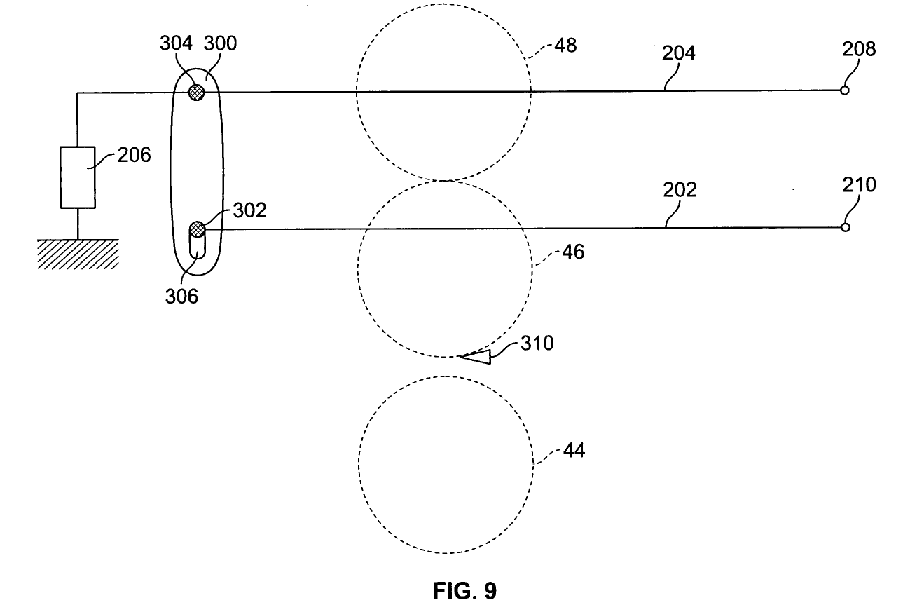

As shown in FIG. 9, the plate cylinder 48 can then contact the blanket cylinder 46 by having the actuator 206 move the support 204 downwardly while wedge 310 supports support 202. FIG. 9 shows the support of FIG. 6 with the blanket cylinder 46 thrown off but contacting plate cylinder 48.

As shown in FIG. 2, a drive gear 280 may drive a blanket cylinder gear 260. The blanket cylinder gear 260 may drive a similar plate cylinder gear. These gears 280, 260 may be axially inside the support 102, i.e. into the page. Due to the tangential arrangement of the gears, the rotation of the support 102 does not cause the gear 260 to disengage from gear 280 (which has an axis which does not translate). In the FIGS. 2, 3, 4, and 5 positions, the blanket cylinder gear 260 and an interacting plate cylinder gear can be driven by gear 280. The motor 72 thus can be used for auto-plating.

The present invention thus provides for large movement of the blanket and plate cylinders in an effective manner while maintaining auto-plating capability.

What is claimed is:

1. An offset web print unit comprising:
a plate cylinder;
a blanket cylinder;
a second blanket cylinder;
an autoplating mechanism, and
a throw-off mechanism including a single actuator both for moving the blanket cylinder from the second blanket cylinder and for moving the blanket cylinder to selectively contact the plate cylinder to permit autoplating while the blanket cylinder is thrown-off of the second blanket cylinder.

2. The offset web print unit as recited in claim I further comprising a blanket support for supporting an end of the blanket and a plate support for supporting an end of the plate.

3. The offset web print unit as recited in claim 2 further comprising frame stop for stopping a movement of the blanket support during throw off so that the plate cylinder moves apart from the blanket cylinder supported by the blanket support.

4. A method for autoplating comprising the steps of:
throwing off a blanket cylinder from a second blanket cylinder using an actuator;
separating a plate cylinder from the blanket cylinder using the actuator; and
plating the plate cylinder with a printing plate.

5. A method for autoplating comprising the steps of:
throwing off a blanket cylinder from a second blanket cylinder using an actuator;
separating a plate cylinder from the blanket cylinder using the actuator; and
plating the plate cylinder with a printing plate;
the plating step including removing a used printing plate from the blanket cylinder.
